(19) United States
(12) Patent Application Publication
(10) Pub. No.: US 2003/0173168 A1
(43) Pub. Date: Sep. 18, 2003

(54) Hydraulic dashpot

(76) Inventors: Ole Gotz, Hamburg (DE); Joerg Starr, Dortmund (DE)

Correspondence Address: Dr. Max Fogiel, 61 Ethel Road West, Piscataway, NJ, 08854, US

(21) Appl. No.: 10/369,912

(22) Filed: Feb. 20, 2003

(30) Foreign Application Priority Data
Feb. 21, 2002 (DE) 102 07 471.2-12

(51) Int. Cl. F16F 9/48

(52) U.S. Cl. 188/289; 188/316

(57) ABSTRACT

A hydraulic dashpot with a cylinder, a piston, a piston rod, and a bypass. The cylinder is charged with hydraulic fluid. The piston divides the cylinder into two chambers, travels up and down inside the cylinder on the inner end of the piston rod as the latter moves in and out of the cylinder, and is provided with ports and valves. The bypass parallels the piston and can be more or less opened and closed. The object is a hydraulic dashpot for vans and station wagons that will be simpler in design and easier to operate with the vehicle either loaded or unloaded and with no detriment to safe driving. The bypass accordingly extends through the piston rod (2), is provided with one exit above the piston (3) and with another exit below it, and the bypass can be more or less opened or closed by a flow-control component fastened to the cylinder (1).

The present invention concerns a hydraulic dashpot as recited in the preamble to claim 1.

Hydraulic dashpots usually include bypasses hydraulically paralleling the piston. The bypasses can be partly or entirely closed to adapt them to various applications. One such is application is in vans and station wagons. In this event, the cross-section of the bypass must be variable enough to ensure convenient operation by automatically increasing the dashpot's performance curve while the vehicle is being loaded and decreasing it while the vehicle is being unloaded. This approach is known from German 33 346 660 A1. It does, however, entail the drawback of requiring complicated controls, an adjustable base valve in the present instance.

The object of the present invention is accordingly a hydraulic dashpot for vans and station wagons that will be simpler in design and easier to operate with the vehicle either loaded or unloaded and with no detriment to safe driving.

This object is attained in accordance with the present invention in a hydraulic dashpot of the aforesaid genus by the characteristics recited in the body of claim 1. Claims 2 through 6 address practical alternative and advanced embodiments.

One advantage of the dashpot in accordance with the present invention is that it requires no extra sensors or controls.

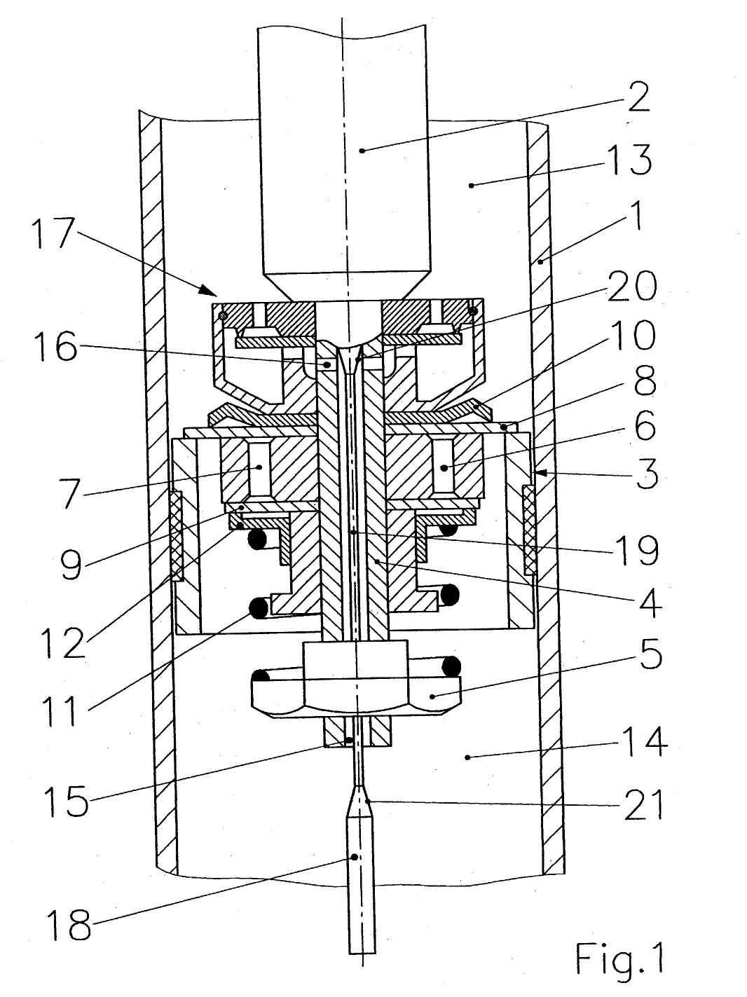

One embodiment of the present invention will now be specified with reference to the accompanying drawing, wherein FIGS. 1 through 6 are sections through a hydraulic dashpot in the vicinity of its piston. Each figure depicts the device at a different stage of operation.

Hydraulic dashpots generally include a piston and cylinder. The piston is mounted on s piston rod and travels up and down inside the cylinder at one end. Only part of the cylinder is depicted in the figures, whereby both the solid end, which is at the bottom in terms of the drawing, and the upper end, through which the piston rod travels in and out, are not depicted. In a single-cylinder dashpot, the same cylinder will constitute both the outer and the inner cylinder and, in a two-cylinder dashpot, the inner cylinder alone.

FIGS. 1 through 6 depict the same areas of a cylinder 1 and piston rod 2. A piston 3 is depicted in section. It is composed of several components mounted on a thinner section of a bolt 4 and secured by a nut 5 screwed onto the bolt's threaded end, with gaskets and spacing sleeves interposed if necessary.

Piston 3 is provided with radial flow-control channels 6 and 7 of differing cross-sections. Channel 6 is maintained closed by a spring-loaded gasket 8. Gasket 8 tends to lift during the piston rod's compression stroke and is kept in place by a spring 10, a cupspring in the illustrated embodiment. Channel 7 is maintained closed by a spring-loaded gasket 9. Gasket 9 tends to lift during the piston rod's decompression stroke and is kept in place by a spring 11, a helical spring in the illustrated embodiment, its force being transmitted to the edge of the gasket by a washer 12.

The interior of cylinder 1 is occupied by hydraulic fluid and divided by piston 3 into two chambers 13 and 14. Spring-loaded gaskets 8 and 9 act, as is conventional in hydraulic dashpots, as checkvalves, and permit a prescribed rate-of-flow dependent attenuation of the fluid flowing through channels 6 and 7 as piston 3 travels in and out. This attenuation will preferably differ in accordance with the direction of travel.

A bypass in the form of a bore 15 extends along the axis of bolt 4 and opens into lower chamber 14. Bore 15 is penetrated at the top by ports 16, through which it communicates with upper chamber 13.

The passage between ports 16 and upper chamber 13 accommodates an “easy-driving” valve 17, which will be specified in detail hereinafter. A bypass in accordance with the present invention can, however, also be operated and controlled without such a special fixture.

A fluid-control component in the form of a portion-dispensing needle 18 is accommodated axially loose inside bore 15. Needle 18 is fastened to cylinder 1 such that piston 3 will move in and out axially in relation to the cylinder. A specified length of the midsection of needle 18 is narrower than the rest, preferably leaving a web 19, past which the fluid can flow. This section merges with the needle's full width at shoulders 20 and 21.

FIG. 1 represents piston 3 in a position relative to needle 18 that leaves the bypass open. Hydraulic fluid can accordingly circulate not only through the opening into piston 3, even without easy-driving valve 17 in operation, but also through the bypass between chambers 13 and 14.

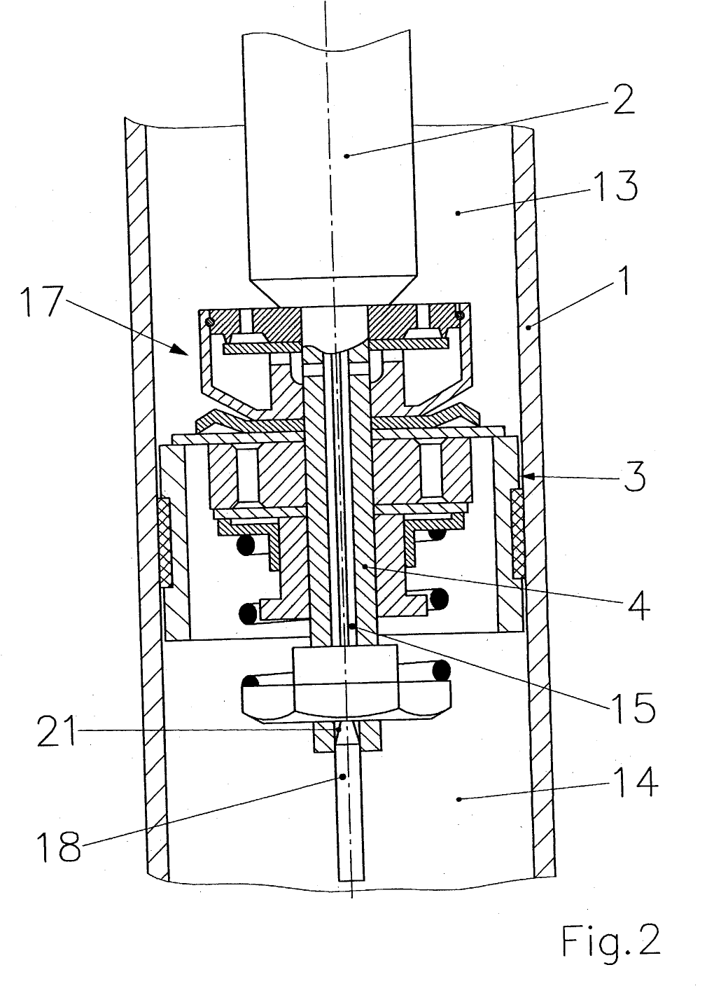

FIG. 2 represents piston 3 farther inside, to the extent that the lower shoulder 21 on needle 18 closes off the lower, open, end of bore 15. With the piston in this position, no fluid can flow through the bypass.

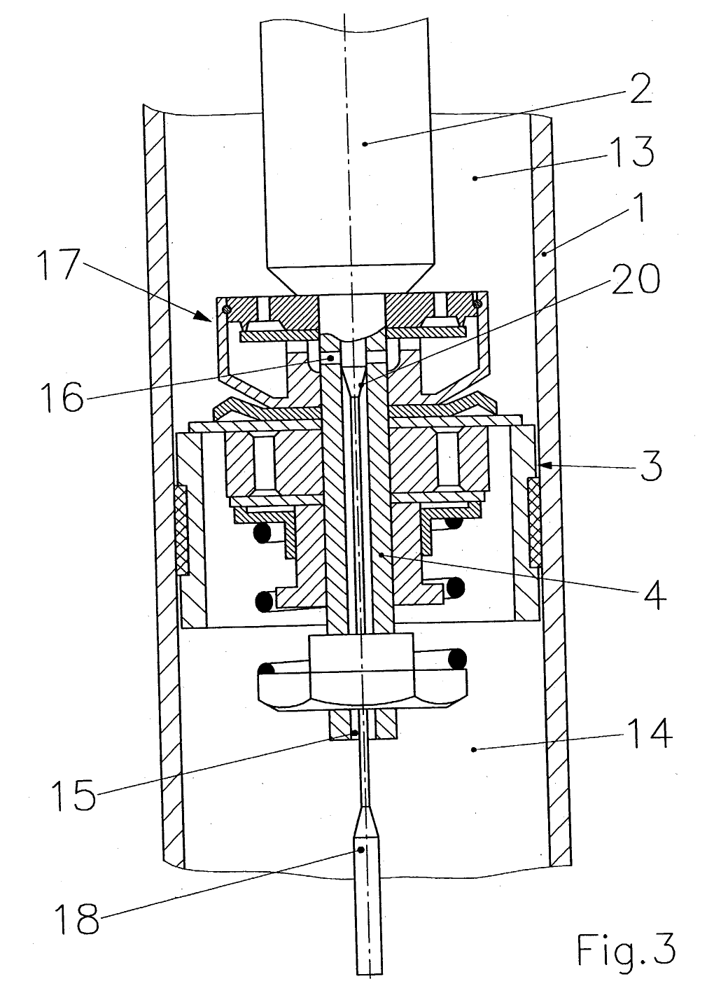

FIG. 3 represents piston 3 in a position higher than the one represented in FIG. 1. With the piston in this position, the upper shoulder 20 of needle 18 closes the bypass's ports 16, and no fluid can flow through it.

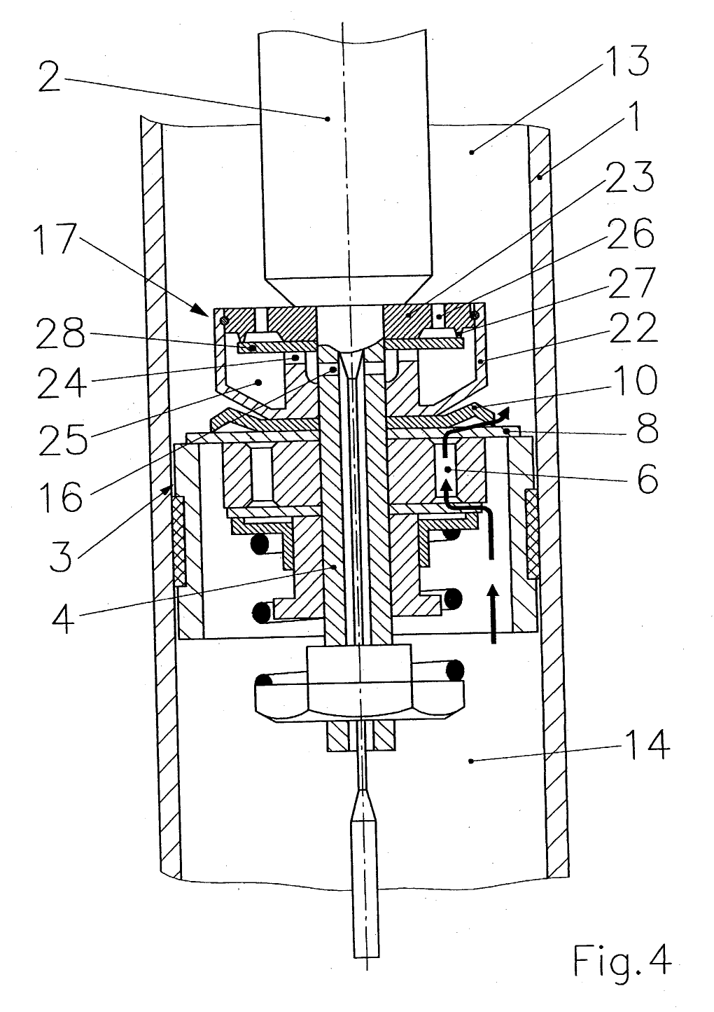

FIGS. 4 through 7 illustrate the structure and operation of easy-driving valve 17. Like valve [sic]3, easy-driving valve 17 encloses the bolt 4 that extends inside piston rod 2. The valve 17 in the illustrated embodiment is positioned above piston 3, against the face, that is, adjacent to piston rod 2. Valve 17 has a bowl-shaped housing 22 with a cap 23. Housing 22 is provided with ports 24 that enable hydraulic communication between the interior 25 of valve 17 and the ports 16 between bolt 4 and the bypass. Cap 23 is provided with outlets 26 and with a seal 27 around its lower surface. A resilient cupspring 28 rests tight against seal 27, valve 17 accordingly blocking the flow during the piston rod's compression stroke and acting as a checkvalve.

FIG. 4 depicts the dashpot during the piston rod's compression stroke, with piston 3 traveling down, that is. In this situation, the pressure in lower chamber 14 is higher than the pressure in upper chamber 13, and fluid can flow through piston 3 only by way of the associated passage 6.

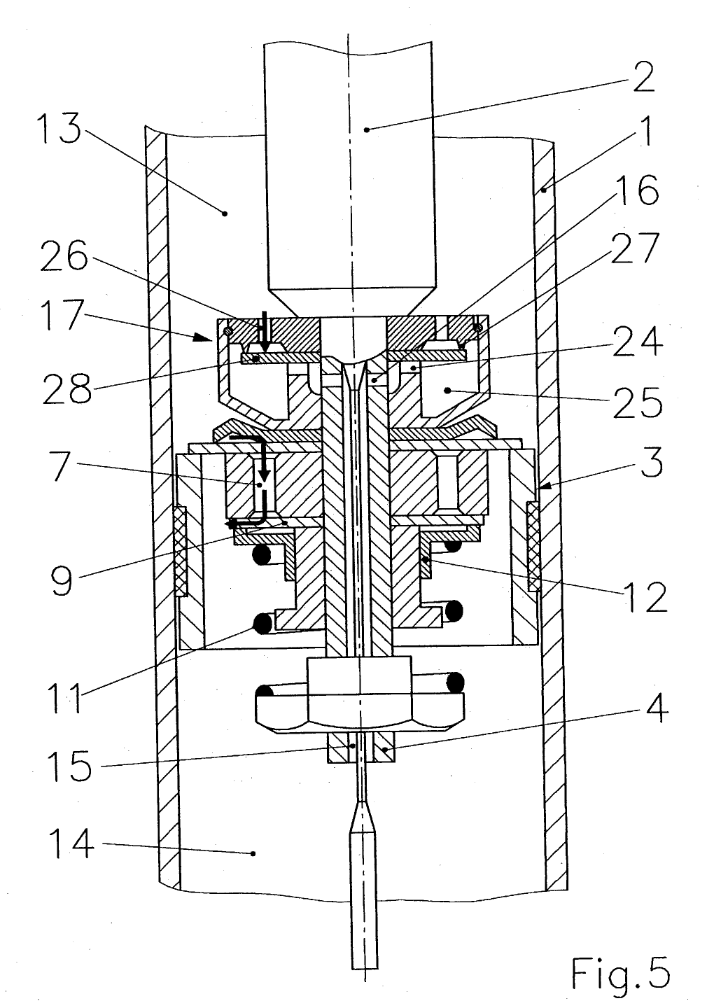

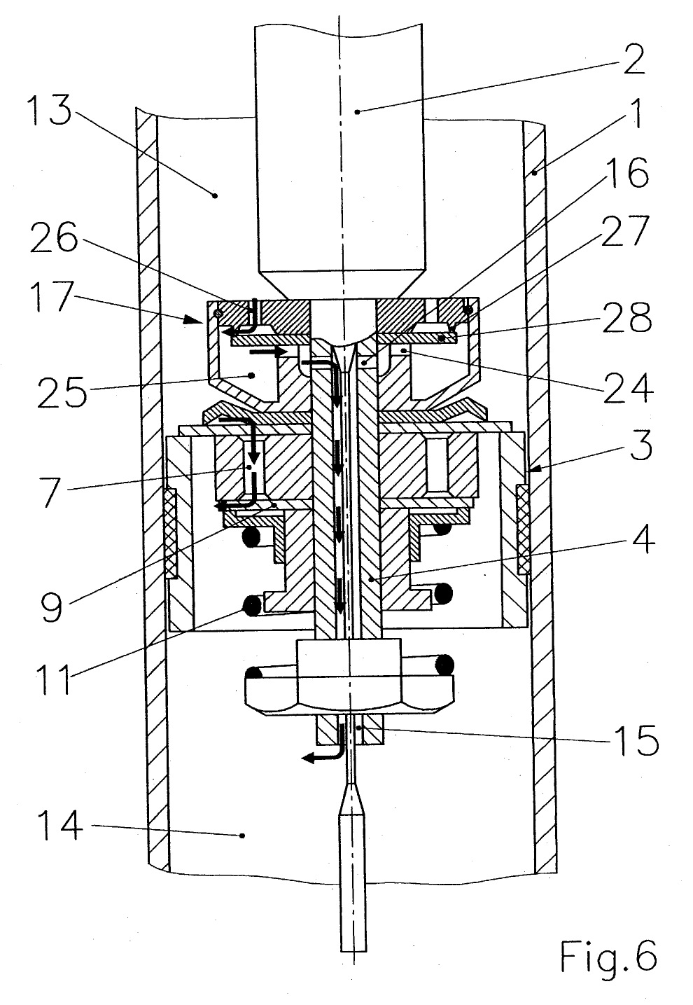

FIGS. 5 and 6 illustrate how piston 3 and easy-driving valve 17 operate during the piston rod's compression stroke,-the pressure in lower chamber 14 higher than that in upper chamber 13. In the state depicted in FIG. 5, this pressure difference is only slight. The fluid lifts gasket 9 and flows through the flow control channel 7 in piston 3. A slight difference between the pressures in the two chambers, that is, is not enough while the piston rod is moving slowly to overcome the resilience of cupspring 28 and separate it from seal 27.

In the state depicted in FIG. 6 on the other hand, the difference between the pressures in the two chambers is enough to separate cupspring 28 from seal 27. This situation occurs while piston 3 is moving up more rapidly, with fluid flowing through channel 6 and through the bypass.

### LIST OF PARTS

1. cylinder

2. piston rod

3. piston

4. bolt

5. nut

6. channel

7. channel

8. gasket

9. gasket

10. spring

11. spring

12. washer

13. upper chamber

14. lower chamber

15. bore

16. port

17. valve

18. needle

19. web

20. shoulder

21. shoulder

22. valve housing

23. cap

24. port

25. interior

26. outlet

27. seal

28. cupspring

1. Hydraulic dashpot with a cylinder, a piston, a piston rod, and a bypass, whereby the cylinder is charged with hydraulic fluid, whereby the piston divides the cylinder into two chambers, travels up and down inside the cylinder on the inner end of the piston rod as the latter moves in and out of the cylinder, and is provided with ports and valves, and whereby the bypass parallels the piston and can be more or less opened and closed, characterized in that the bypass extends through the piston rod (2), 00 is provided with one exit above the piston (3) and with another exit below it, and in that the bypass can be more or less opeoned or closed by a flow control component fastened to the cylinder (1).

2. Hydraulic dashpot as in claim 1, characterized by s bore (15) extending along the central axis of the piston rod (2) and in that the flow-control component is a portion-dispensing needle (18) fastened to the solid end of the cylinder (1) or to a fixture in that vicinity.

3. Hydraulic dashpot as in claim 2, characterized in that the section of the needle (18) in the vicinity of the bore (15) is narrower than the rest of the needle and longer than the bypass.

4. Hydraulic dashpot as in one or more of claims 1 through 3, characterized in that at least one opening into the bypass is maintained closed by a spring-loaded checkvalve.

5. Hydraulic dashpot as in claim 4, characterized in that the checkvalve tends to open parallel to a decompression stroke on the part of the piston rod (2).

6. Hydraulic dashpot as in claim 4 or 5, characterized in that the force exerted on the checkvalve by the spring is powerful enough to maintain the checkvalve closed when the difference between the pressures in the two chambers (13 & 14) is slight.
